(19) United States
(12) Patent Application Publication
(10) Pub. No.: US 2026/0268885 A1
(43) Pub. Date: Sep. 10, 2026

(54) ULTRASONIC TRANSDUCER

(71) Applicant: QISDA CORPORATION, Taoyuan City (TW)

(72) Inventor: Fu-Sheng Jiang, Taoyuan City (TW)

(73) Assignee: QISDA CORPORATION, Taoyuan City (TW)

(21) Appl. No.: 19/467,839

(22) Filed: Feb. 3, 2026

(30) Foreign Application Priority Data
Mar. 10, 2025 (TW) 114108719

(51) Int. Cl. G10K 11/30; G01S 7/52; G10K 9/122; G10K 11/02; G10K 11/162

(52) U.S. Cl. CPC G10K 11/30; G01S 7/52077; G01S 7/52079; G10K 9/122; G10K 11/02; G10K 11/162

(57) ABSTRACT

An ultrasonic transducer of increasing a signal-to-noise ratio includes a shock absorption layer, a transducing module and an acoustic lens. The transducing module is disposed on the shock absorption layer. The acoustic lens is disposed on the transducing module and opposite to the shock absorption layer, and includes a plurality of flake structures having the same curvature. A structural height of each of the plurality of flake structures is defined as having a preset difference compared to a substrate thickness. An application wavelength of the ultrasonic transducer is derived from a central frequency of the ultrasonic transducer and a sound speed of the acoustic lens. The substrate thickness is a sum of an integral multiple of half of the application wavelength and one eighth of the application wavelength. The preset difference is a numerical range greater than zero and smaller than or equal to one quarter of the application wavelength.

### BACKGROUND OF THE INVENTION

### 1. Field of the Invention

The present invention relates to an ultrasonic transducer, and more particularly, to an ultrasonic transducer of increasing the signal-to-noise ratio.

### 2. Description of the Prior Art

A conventional ultrasonic transducer includes a shock absorption layer, an acoustic lens, a piezoelectric material layer and an acoustic resistance matching layer. The piezoelectric material layer is disposed on a side of the shock absorption layer nearby the acoustic lens. The acoustic resistance matching layer is disposed between the piezoelectric material layer and the acoustic lens. The emitting surface of the conventional ultrasonic transducer is a rectangular surface with a long axis and a short axis. The curvature of the emitting surface does not have an ideal focusing effect of the ultrasonic wave in a direction of the short axis, thus resulting in a disadvantage of uneven energy distribution. The conventional ultrasonic transducer has additional energy distribution in the direction of the short axis, which causes the side lobe effect, and energy of the ultrasonic wave is diffused and significantly attenuated. Therefore, design of an ultrasonic transducer that can improve a signal-to-noise ratio and avoid the side lobe effect is an important issue in the related medical equipment industry.

### SUMMARY OF THE INVENTION

The present invention provides an ultrasonic transducer of increasing the signal-to-noise ratio for solving above drawbacks.

According to one embodiment, an ultrasonic transducer of increasing a signal-to-noise ratio includes a shock absorption layer, a transducing module and an acoustic lens. The transducing module is disposed on the shock absorption layer. The acoustic lens is disposed on a side of the transducing module opposite to the shock absorption layer, and includes a plurality of flake structures having the same curvature. A structural height of each of the plurality of flake structures is defined as having a preset difference compared to a substrate thickness. The substrate thickness is equal to a sum of an integral multiple of half of an application wavelength of the ultrasonic transducer and one eighth of the application wavelength. The preset difference is a numerical range greater than zero and smaller than or equal to one quarter of the application wavelength.

The ultrasonic transducer of the present application can significantly shorten the film thickness of the acoustic lens without changing the radius of curvature of the acoustic lens, so that a protruding height of each flake structure of the acoustic lens relative to the substrate can be far away from the sum of the integral multiple of the application wavelength and one eighth of the application wavelength; that is, the preset difference between the structural height of the flake structure and the substrate thickness can be designed as the numerical range greater than zero and smaller than or equal to one quarter of the application wavelength, which can have advantages of increasing the overall signal strength and reducing the side lobe effect, thereby effectively improving the signal-to-noise ratio of the ultrasonic transducer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simple structural diagram of an ultrasonic transducer according to an embodiment of the present application.

FIG. 2 is a simple structural diagram of an acoustic lens according to a first embodiment of the present application.

FIG. 3 is a simple structural diagram of the acoustic lens according to a second embodiment of the present application.

FIG. 4 is a simple structural diagram of the acoustic lens according to a third embodiment of the present application.

FIGS. 5 to 7 are simple structural diagrams of the acoustic lens according to different embodiments of the present application.

### DETAILED DESCRIPTION

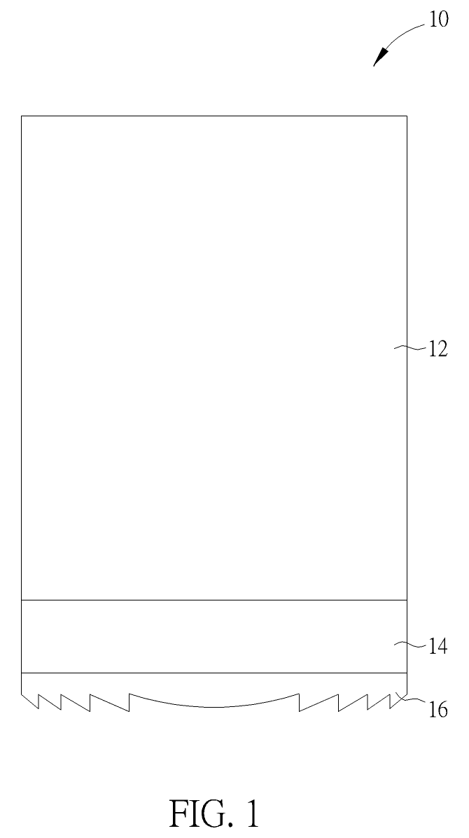

Please refer to FIG. 1. FIG. 1 is a simple structural diagram of an ultrasonic transducer 10 according to an embodiment of the present application. The ultrasonic transducer 10 can at least include a shock absorption layer 12, a transducing module 14 and an acoustic lens 16. The shock absorption layer 12 can be adhesive material. The transducing module 14 can include a piezoelectric material layer and an acoustic resistance matching layer (which are not marked in the figure). The acoustic resistance matching layer can be located between the shock absorption layer 12 and the acoustic lens 16. The piezoelectric material layer can be located between the shock absorption layer 12 and the acoustic resistance matching layer. The acoustic lens 16 can be disposed on a side of the transducing module 14 opposite to the shock absorption layer 12. The acoustic lens 16 of the present application can have specific design of eliminating false images and preventing a side lobe effect to improve a signal-to-noise ratio via thickness reduction of the acoustic lens 16.

The acoustic lens 16 can be set on an ultrasonic transmission path of the ultrasonic transducer 10, and have an acoustic resistance matching function, so the acoustic lens 16 can be interpreted as a part of the acoustic resistance matching layer. The acoustic resistance matching layer can reduce reflection of the ultrasonic wave to improve energy transfer efficiency. An application wavelength of the ultrasonic transducer 10 can correspond to a center frequency of the ultrasonic transducer 10 and a sound speed of the acoustic lens 16. For example, as if the center frequency is 10 MHz and the sound speed is 1 mm/us, the application wavelength can be computed to be 0.1 mm. Actual values of the center frequency, the sound speed and the application wavelength can depend on product specification, and a detailed description is omitted herein for simplicity.

When the thickness of the acoustic resistance matching layer is equal to an odd multiple of one quarter of the application wavelength, the ultrasonic wave can be reflected inside the acoustic lens 16 (or be reflected between the acoustic resistance matching layer and an external media), and the reflection wave can be in opposite phase to the incident wave and can be canceled each other out. When the thickness of the acoustic resistance matching layer is equal to one-half of the application wavelength, the reflection wave and the incident wave of the ultrasonic wave within the acoustic lens 16 can be in the same phase; the energy cannot pass through theacoustic resistance matching layer to be reflected, and other remaining area can show a partial reflection and partial refraction phenomenon. Therefore, the present application can design the acoustic lens 16 as deformation of a Fresnel lens, so as to achieve a purpose of improving the signal-to-noise ratio.

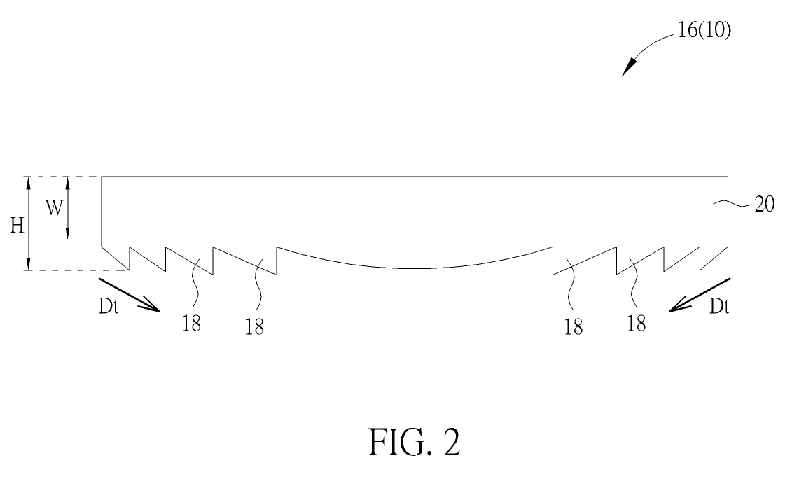

Please refer to FIG. 2. FIG. 2 is a simple structural diagram of the acoustic lens 16 according to a first embodiment of the present application. The acoustic lens 16 can include a plurality of flake structures 18 having the same curvature, and an end of the plurality of flake structures 18 nearby the transducing module 14 can be defined as a substrate 20. The plurality of flake structures 18 can have the same structural height H. The substrate 20 can have a substrate thickness W. A preset difference can be allowed between the structural height H and the substrate thickness W, so as to reduce the side lobe effect. In the first embodiment, the substrate thickness W can be equal to a sum of an integral multiple (e.g., zero or any positive integer) of half of the application wavelength and one eighth of the application wavelength. The preset difference can be designed as a numerical range greater than zero and smaller than or equal to one quarter of the application wavelength. That is to say, the structural height H can be preferably designed as a sum of the substrate thickness W and one quarter of the application wavelength. A film thickness of the acoustic lens 16 can be relatively thin and only slightly attenuate the energy, which belongs to the preferred embodiment; however, the actual application is not limited to this.

In addition, a vertex direction Dt of the flake structure 18 on the side of the first embodiment can be set towards center of the acoustic lens 16, but the actual application is not limited thereto. The present application can decide the vertex direction Dt in accordance with media difference between the acoustic lens 16 and its environment, which means the vertex direction Dt can correspond to the media difference between the acoustic lens 16 and an adjacent component. The foresaid adjacent component can be air around the acoustic lens 16, or a target object to be measured by the ultrasonic transducer 10, and variation of the adjacent component can depend on a design demand.

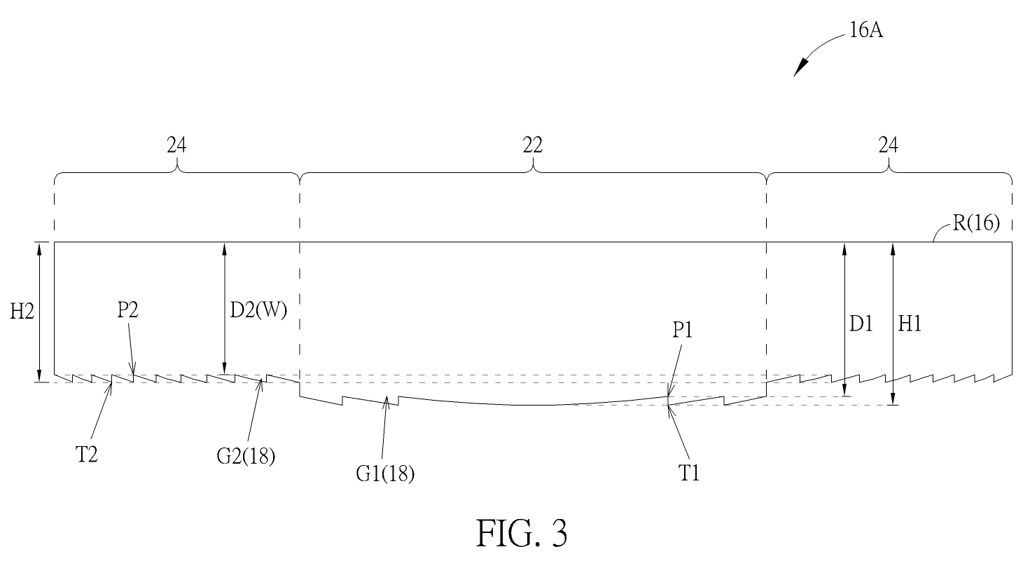

Please refer to FIG. 3. FIG. 3 is a simple structural diagram of the acoustic lens 16A according to a second embodiment of the present application. The plurality of flake structures 18 of the acoustic lens 16A can be divided into a first group G1 and a second group G2. The first group G1 can be located on a center region 22 of the acoustic lens 16A. The second group G2 can be located on a peripheral region 24 of the acoustic lens 16A to surround the first group G1 of the center region 22. The structural height H1 of plural flake structures 18 in the first group G1 can be greater than the structural height H2 of plural flake structures 18 in the second group G2, thereby forming the acoustic lens 16A with an inner convex and outer concave feature.

In the second embodiment, the structural height H2 (such as a distance between a top end T2 of each flake structure 18 and a reference plane R of the acoustic lens 16) of the plural flake structures 18 in the second group G2 can be optionally designed as a sum of the substrate thickness W and one quarter of the application wavelength. A distance D2 between a turning point P2 of adjacent flake structures 18 in the second group G2 and the reference plane R of the acoustic lens 16 can be optionally designed as a sum of the integral multiple of half of the application wavelength and one eighth of the application wavelength, which means the distance D2 can be equal to the substrate thickness W in the first embodiment.

Accordingly, a distance D1 between a turning point P1 of adjacent flake structures 18 in the first group G1 and the reference plane R of the acoustic lens 16 can be designed as a sum of the substrate thickness W and the integral multiple of one-half of the application wavelength. The distance (e.g., the structural height H1) between a top end T1 of each flake structure 18 in the first group G1 and the reference plane R of the acoustic lens 16 can be designed as a sum of the distance D1 between the turning point P1 and the reference plane R and one quarter of the application wavelength. It should be mentioned that computation relation of the distance D2 (such as the substrate thickness W), the structural height H2, the distance D1 and the structural height H1 relative to the application wavelength is not limited to the foresaid embodiments, and may have an allowable error of 10% to 15% depending on an actual situation.

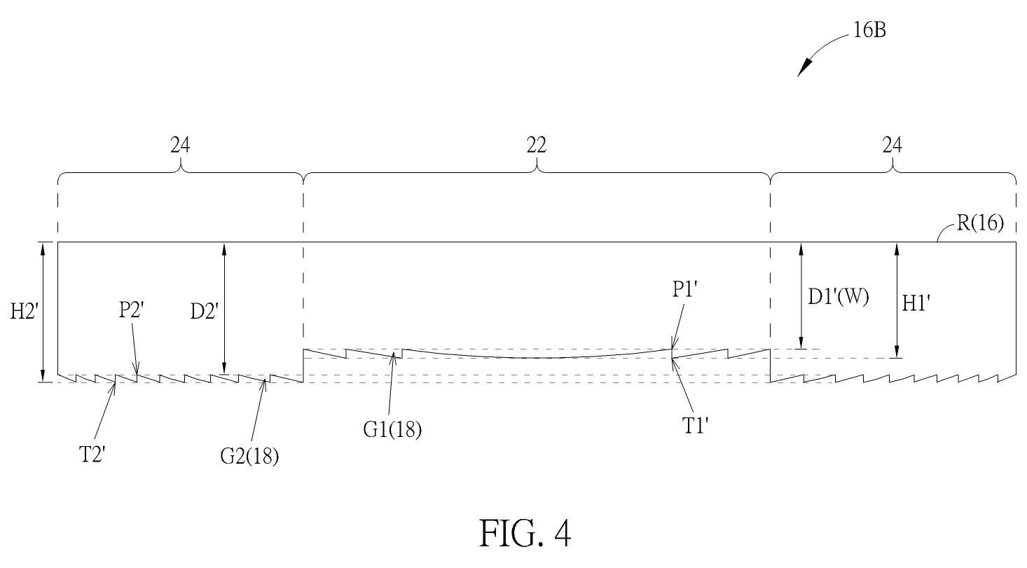

Please refer to FIG. 4. FIG. 4 is a simple structural diagram of the acoustic lens 16B according to a third embodiment of the present application. The plurality of flake structures 18 of the acoustic lens 16B can be divided into the first group G1 and the second group G2. The first group G1 can be located on the center region 22 of the acoustic lens 16B. The second group G2 can be located on the peripheral region 24 of the acoustic lens 16B to surround the first group G1 on the center region 22. In the third embodiment, the structural height H1’ of plural flake structures 18 in the first group G1 can be smaller than the structural height H2’ of plural flake structures 18 in the second group G2, thereby forming the acoustic lens 16B with an inner concave and outer convex feature.

In the third embodiment, the structural height H1’ (such as the distance between the top end T1’ of each flake structure 18 and the reference plane R of the acoustic lens 16) of the plural flake structures 18 in the first group G1 can be optionally designed as a sum of the substrate thickness W and one quarter of the application wavelength. The distance D1’ between the turning point P1’ of the adjacent flake structures 18 in the first group G1 and the reference plane R of the acoustic lens 16 can be optionally designed as a sum of the integral multiple of half of the application wavelength and one eighth of the application wavelength, which means the distance D1’ can be equal to the substrate thickness W in the first embodiment.

Accordingly, the distance D2’ between the turning point P2’ of the adjacent flake structures 18 in the second group G2 and the reference plane R of the acoustic lens 16 can be designed as a sum of the substrate thickness W and the integral multiple of one-half of the application wavelength. The distance (e.g., the structural height H2’) between the top end T2’ of each flake structure 18 in the second group G2 and the reference plane R of the acoustic lens 16 can be designed as a sum of the distance D2’ between the turning point P2’ and the reference plane R and one quarter of the application wavelength. It should be mentioned that computation relation of the distance D1’ (such as the substrate thickness W), the structural height H1’, the distance D2’ and the structural height H2’ relative to the application wavelength is not limited to the foresaid embodiments, and may have the allowable error of 10% to 15% depending on the actual situation.

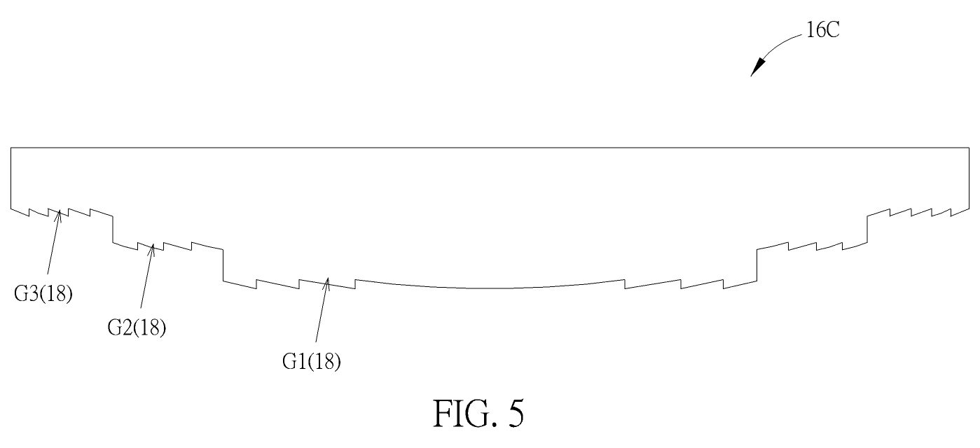

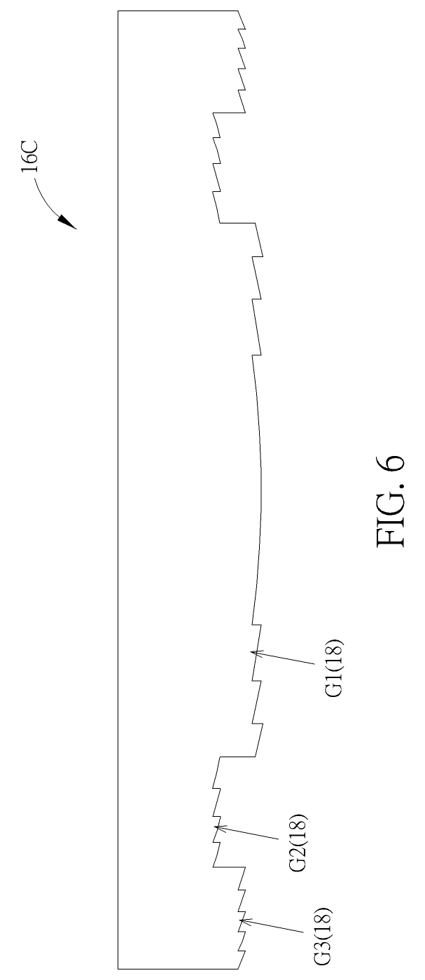

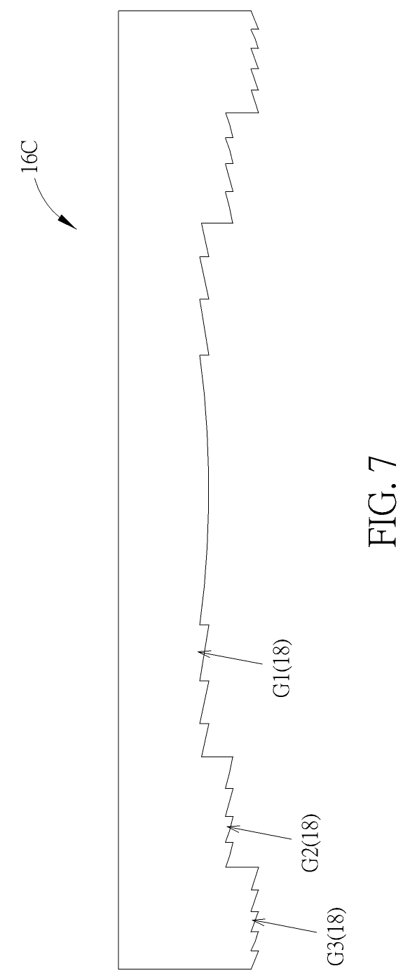

Please refer to FIGS. 5 to 7. FIGS. 5 to 7 are simple structural diagrams of the acoustic lens 16C according to different embodiments of the present application. The plurality of flake structures 18 of the acoustic lens 16C can be further divided into the first group G1, the second group G2 and a third group G3. The first group G1 can be located on the center region of the acoustic lens 16C. The second group G2 can be located between the first group G1 and the third group G3. As the embodiment shown in FIG. 5, the structural height of the first group G1 can be greater than the structural height of the second group G2, and the structural height of the second group G2 can be greater than the structural height of the third group G3. As the embodiment shown in FIG. 6, the structural height of the first group G1 can be greater than the structural height of the second group G2, and the structural height of the second group G2 can be smaller than the structural height of the third group G3. As the embodiment shown in FIG. 7, the structural height of the first group G1 can be smaller than the structural height of the second group G2, and the structural height of the second group G2 can be smaller than the structural height of the third group G3. FIGS. 5 to 7 indicate that the plurality of flake structures 18 can be divided into three or more groups, and the groups can have two or more structural heights. Variation of the groups divided by the flake structures 18 can depend on the design demand, and the detailed description is omitted herein for simplicity.

In conclusion, the ultrasonic transducer of the present application can significantly shorten the film thickness of the acoustic lens without changing the radius of curvature of the acoustic lens, so that a protruding height of each flake structure of the acoustic lens relative to the substrate can be far away from the sum of the integral multiple of the application wavelength and one eighth of the application wavelength; that is, the preset difference between the structural height of the flake structure and the substrate thickness can be designed as the numerical range greater than zero and smaller than or equal to one quarter of the application wavelength, which can have advantages of increasing the overall signal strength and reducing the side lobe effect, thereby effectively improving the signal-to-noise ratio of the ultrasonic transducer.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An ultrasonic transducer of increasing a signal-to-noise ratio, the ultrasonic transducer comprising:
a shock absorption layer;
a transducing module disposed on the shock absorption layer; and
an acoustic lens disposed on a side of the transducing module opposite to the shock absorption layer, and comprising a plurality of flake structures having the same curvature, a structural height of each of the plurality of flake structures being defined as having a preset difference compared to a substrate thickness;
wherein the substrate thickness is equal to a sum of an integral multiple of half of an application wavelength of the ultrasonic transducer and one eighth of the application wavelength;
wherein the preset difference is a numerical range greater than zero and smaller than or equal to one quarter of the application wavelength.

2. The ultrasonic transducer of claim 1, wherein the plurality of flake structures has the same structural height.

3. The ultrasonic transducer of claim 2, wherein the structural height is equal to a sum of the substrate thickness and one quarter of the application wavelength.

4. The ultrasonic transducer of claim 1, wherein the plurality of flake structures is divided into a first group and a second group, the first group is located on a center region of the acoustic lens, the second group is located on a peripheral region of the acoustic lens to surround the center region.

5. The ultrasonic transducer of claim 4, wherein the structural height of some flake structures in the first group is greater than the structural height of some flake structures in the second group.

6. The ultrasonic transducer of claim 5, wherein the structural height of each flake structure in the second group is equal to a sum of the substrate thickness and one quarter of the application wavelength.

7. The ultrasonic transducer of claim 5, wherein a distance between a turning point of adjacent flake structures in the first group and a reference plane of the acoustic lens is equal to a sum of the substrate thickness and an integral multiple of half of the application wavelength.

8. The ultrasonic transducer of claim 7, wherein a distance between a top end of each flake structure in the first group and the reference plane of the acoustic lens is equal to a sum of the distance between the turning point and the reference plane and one quarter of the application wavelength.

9. The ultrasonic transducer of claim 4, wherein the structural height of some flake structures in the first group is smaller than the structural height of some flake structures in the second group.

10. The ultrasonic transducer of claim 9, wherein the structural height of each flake structure in the first group is equal to a sum of the substrate thickness and one quarter of the application wavelength.

11. The ultrasonic transducer of claim 9, wherein a distance between a turning point of adjacent flake structures in the second group and a reference plane of the acoustic lens is equal to a sum of the substrate thickness and an integral multiple of half of the application wavelength.

12. The ultrasonic transducer of claim 11, wherein a distance between a top end of each flake structure in the second group and the reference plane of the acoustic lens is equal to a sum of the distance between the turning point and the reference plane and one quarter of the application wavelength.

13. The ultrasonic transducer of claim 1, wherein the plurality of flake structures is divided into a first group, a second group and a third group, the first group is located on a center region of the acoustic lens, the second group is located between the first group and the third group, the first group and the second group and the third group have at least two structural heights.

14. The ultrasonic transducer of claim 1, wherein a vertex direction of the plurality of flake structures is designed in accordance with media difference between the acoustic lens and an adjacent component.
